(19) United States
(12) Patent Application Publication
(10) Pub. No.: US 2018/0341241 A1
(43) Pub. Date: Nov. 29, 2018

(54) Cloud-Based Integration Rule Engine to Enable Plug and Play Device for Building Automation Systems

(71) Applicant: Siemens Corporation, Iselin, NJ (US)

(72) Inventor: Zhen Song, Plainsboro, NJ (US)

(21) Appl. No.: 15/603,205

(22) Filed: May 23, 2017

(51) Int. Cl. G05B 19/042

(52) U.S. Cl. CPC G05B 19/0426; G05B 2219/2614; G05B 2219/2642

(57) ABSTRACT

An approach for configuration and modification of building automation systems by end users using a cloud-based integration rule engine using encapsulate state machine containers.

### TECHNICAL FIELD

The present invention relates generally to building automation systems and more particularly, to the engineering and modification of building automation systems' control logic.

### BACKGROUND

Most modern buildings are built with security systems, emergency systems, and heating, ventilating, and air conditioning (HVAC) systems, all of which have many sensors, fans, values, and actuators. These systems together are commonly referred to as a building automation system (BAS). Many of these devices are controlled by microcontroller or microprocessor located in field panels. The programming of each panel is often unique based upon the different devices coupled to the panel. The initial provisioning of a BAS takes multiple hours to layout the design, develop the programming logic for the panels and other programmable devices, program the devices, integrating the different devices by adjusting their control logic, and testing the devices and programs. It takes many hours, if not days to properly commission a BAS and many months to properly train technicians how to integrate and change the different devices in the BAS. Thus, the costs associated with the commissioning and debugging of a BAS is often part of an estimate for selling the components that make up the system.

Current approaches at automating configuration of a BAS and other systems have had mixed results with all of them failing to provide complete configurations. Even when a configuration is finished to an acceptable level, modification is time consuming with a significant labor cost. Modification of a BAS often requires specific knowledge of programming and the systems in the BAS, which cannot easily be done by users of the BAS.

In view of the foregoing, there is an ongoing need for systems, apparatuses and methods for reducing the labor costs and time to implement changes to a BAS and skill level of the people making the changes while reducing human errors that occur when changing the BAS.

### SUMMARY

An approach for engineering and integration of a building automation system (BAS) is implemented with an XML-based script language or similar programming language, where the programming language can refer to external code that is provided for configuration and integration of components and subsystems within the BAS. The interactive control logic among different components are presented in finite state machines (FSMs) and captured by the XML-based or similar script language. The control logics of different FSMs are isolated or grouped into different containers that may be represented as XML or similar files with their associated behaviors and accessed in an event-driven paradigm. A cloud-based integration rule engine (CIRE) has both components stored in the cloud and hardware devices in the building. The control logic for different integration methods are captured by XML files or similar files and stored in the cloud. Once the user (field engineer) selects an integration scenario, the associated XML files are accessed by or downloaded to a local processor control device in the building. The local processor controlled device hosts a rule engine, which accepts multiple containers and automatically merges the control logic together. The local control device takes the role of the orchestrator and interacts with different components. This approach significantly simplifies the manual workload of merging control logic code of the BAS and overcomes the traditional sequential programming (such as using ‘GOTO’ like commands) or Object Oriented Programming (OOP) approach limitations. The isolated state machine approach is disclosed herein applied to building control domain, where automatic merging of state machines is available to non-developers. A rule based system is presented with encapsulated finite state machines that has rule engine (with both cloud and local components) to realize the state machine based system integration approach.

Other devices, apparatus, systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The invention can be better understood by referring to the following figures. The components in the figures are not necessarily to scale, emphasis instead being placed upon illustrating the principles of the invention. In the figures, like reference numerals designate corresponding parts throughout the different views.

FIG. 1 is an illustration of a processor controlled device that is able to take state machines that are isolated or grouped into files with their associated behaviors and modify when used to control instructions for HVAC panels in accordance with an example implementation of the invention.

FIG. 2 is a graphical illustration of part of a BAS implementation in accordance with and example implementation of the invention.

FIG. 3 is a rule for blind control in the BAS depicted in a processor control device of FIG. 1 in accordance with an example implementation.

FIG. 4 is an architecture diagram of the CIRE system accessed by the processor control device of FIG. 1 to configure the BAS in accordance with an example implementation.

FIG. 5 is a flow diagram of an encapsulated state machine approach to management of the BAS of FIG. 2 executed on processor control device of FIG. 1 in accordance with an example implementation.

### DETAILED DESCRIPTION

As used herein, an approach is described for provisioning controllers in a BAS that control a plurality of points and associated information automatically in response to being prompted for initial configuration information.

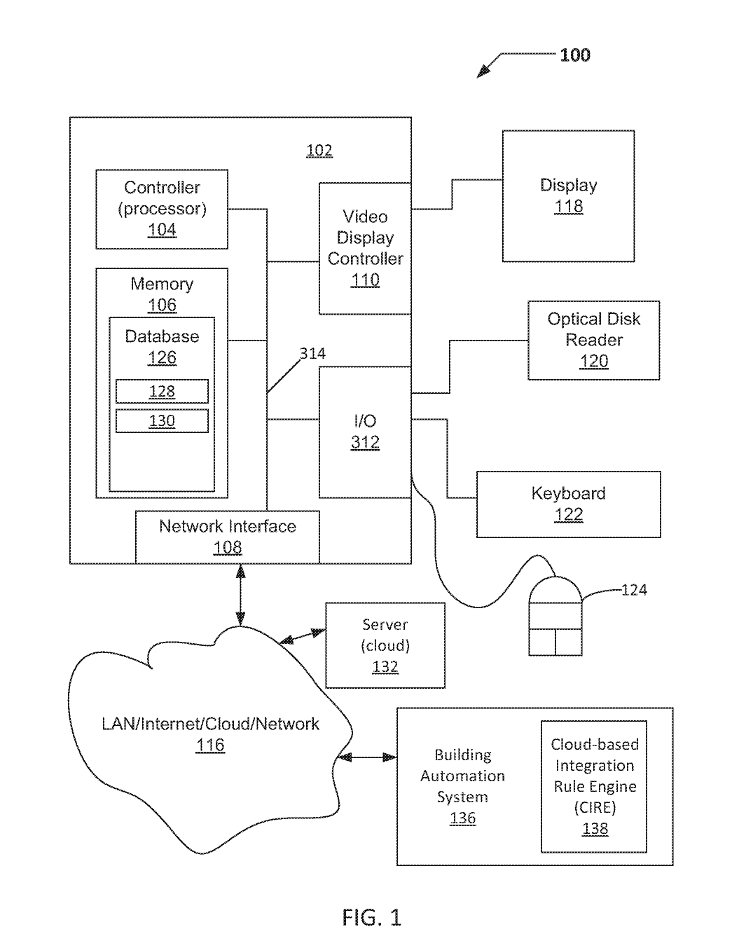

Turning to FIG. 1, an illustration 100 of a processor controlled device that is able to access a server 132 containing a plurality of state machine modules that control a plurality of points in a HVAC panel in accordance with an example implementation of the invention is depicted. The processor controlled device 102 has a controller 104 (processor) coupled to a memory 106, network interface 108, video controller 110, and input/output (I/O) interface 112 by address/data bus 114. The network interface 108 may couple the processor controlled device 302 to a network, such as one or more local area networks (LANs)/internet/cloud 116 and a cloud server 132 in the cloud, and a building automation system (BAS) 136. The connection to the LANs/internet/cloud 116 may be wired or wireless (such as 802.11g or 802.11n). The video controller 110 may be coupled to one or more displays, such as display 118. The display is typically a digital video displays, such as HD televisions or VGA computer displays. The I/O interface 112 may be coupled to a keyboard 122, optical disk reader 120, and mouse 124. The BAS 136 includes a cloud-based integration rule engine 138.

The controller 104 may execute instructions that may be stored in memory 106 that facilitate the operation of the processor controlled device 102. The memory 106 may be logically or physically split into an operational memory 128 that provide operational instructions for the processor controlled device 102 and an application memory 130 that may have one or more applications and/or databases/data stores, such as an application store. In other implementations, the application memory 130 may be dedicated to one application.

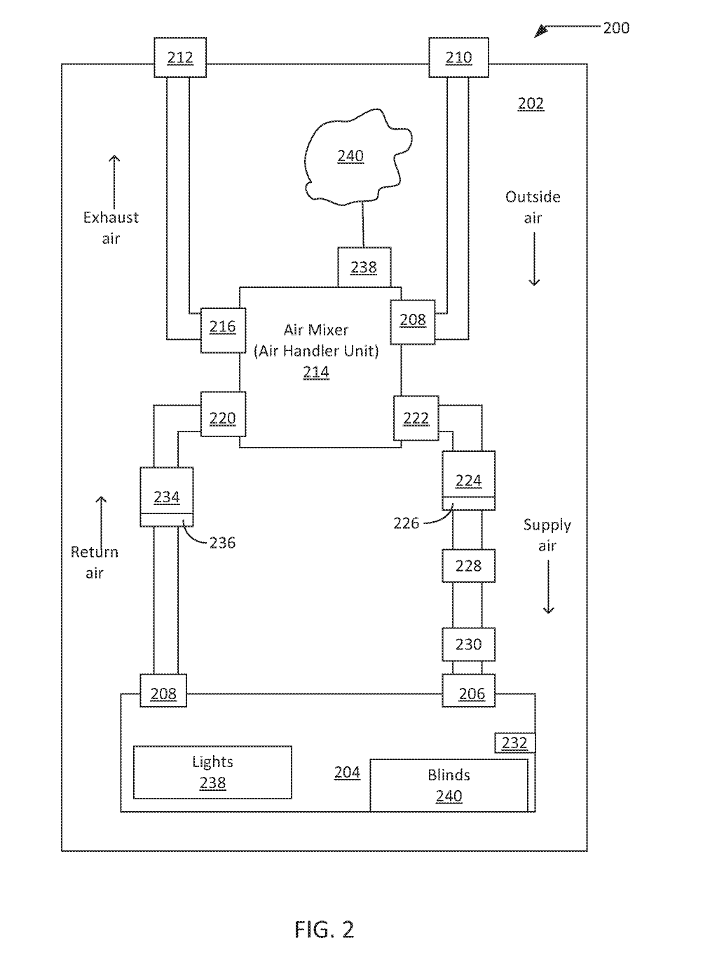

In FIG. 2, a graphical illustration of part of a BAS 200 in accordance with and example implementation of the invention is depicted. A building 202 with a room 204 has a supply air vent 206 and return air vent 208. Outside air is brought into the building via an outside inlet vent 210 and exhausted via outside exhaust vent 212. An air mixer 214 may have an exhaust air damper 214, outdoor air damper 218, return air damper 220, and supply air damper 214. A supply fan 224 may aid in moving the supply air and have a supply variable frequency drive 226. A heating supply control valve 228 may control the heating of the supply air and similarly a supply air cooling valve 230 may control the cooling of the supply air, and thermostat may also be present in room 204. Return air exits the room 204 via the return air vent 208 and may be aided by return fan 234 that may be controlled by return variable frequency drive 236. The return air enters the air mixer 214 via return air damper 220. The room 204 may also have lighting control 238 and blind control 240 as shown in FIG. 2. All the devices may be controlled by one or more field panels, such as panel 238 that control the different elements of the BAS.

The field panel may be directly or indirectly coupled to a building's telecommunication network 240 and/or the internet/cloud. The field panel may have one or microcontrollers that are programmed to operate the different components of the BAS.

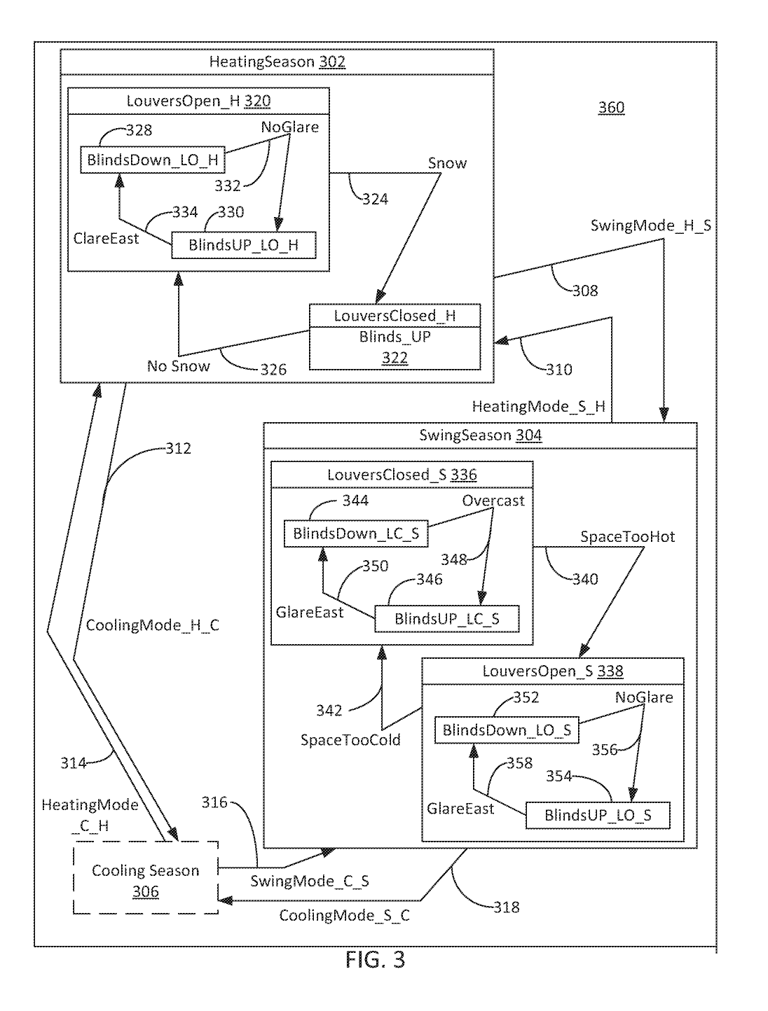

Turning to FIG. 3, a rule for blinds 240 of FIG. 2 in the BAS 200 depicted on the display 118 processor control device 102 of FIG. 1 in accordance with an example implementation of the invention. The approach is applicable to the integration of networked controllers in the BAS 200, and in an actual implementation may include additional devices such as boilers, chillers, rooftop units, terminal units (variable air volume) air handling units, lamps, motorized windows, sensors, mobile devices, and wearable devices. The rules are grouped into containers, such as heating season “HeatingSeason” 302, Swing Season “SwingSeason” 304, and Cooling Season 306 that control the blinds (240). Each container 302-306, is a state machine that contains instructions for execution by processors in panels that control the points in a building. Control signals are depicted as transitions between containers, such as control signal 308-318.

The container “HeatingSeason” 302 has instructions for the building automation system during the heating season. Additional state machines may exist in container “HeatingSeason” 302 for control during other time periods and control of devices. “HeatingSeason” 302 container has a “LouversOpen_H” container state machine 320, and “LouversClosed_H” container state machines 322 that are transitioned between by control signals “Snow” 324 and “No Snow” 326. The “LouversOpen_H” container 320 contains “BlindsDown_LO_H” container 328 and “BlindsUP_LO_H” container 330 that are transitioned by control signals “NoGlare” 332 and “ClearEast” 334.

“SwingSeason” state machine container 304 has “LouversClosed_S” container 336 and “LouversOpen_S” state machine container 338 that are transitioned between with control signals “SpaceTooHot” 340 and “SpaceTooCold” 342. The “LouversClosed_S” state machine container 336 has “BlindsDown_LC_S” container 344 and “BlindsUP_LC_S” container 346 that are transitioned between by control signals “Overcast” 348 and “GlareEast” 350. The “LouversOpen_S” state machine container 338 has “BlindsDown_LO_S” container 352 and “BlindsUP_LO_S” container 354 that are transitioned between with control signals “NoGlare” 356 and “GlareEast” 358. In practice, additional state machine containers will be in use by the building automation system and will be dependent upon the types of controllers, sensors, and HVAC equipment employed to control a BAS.

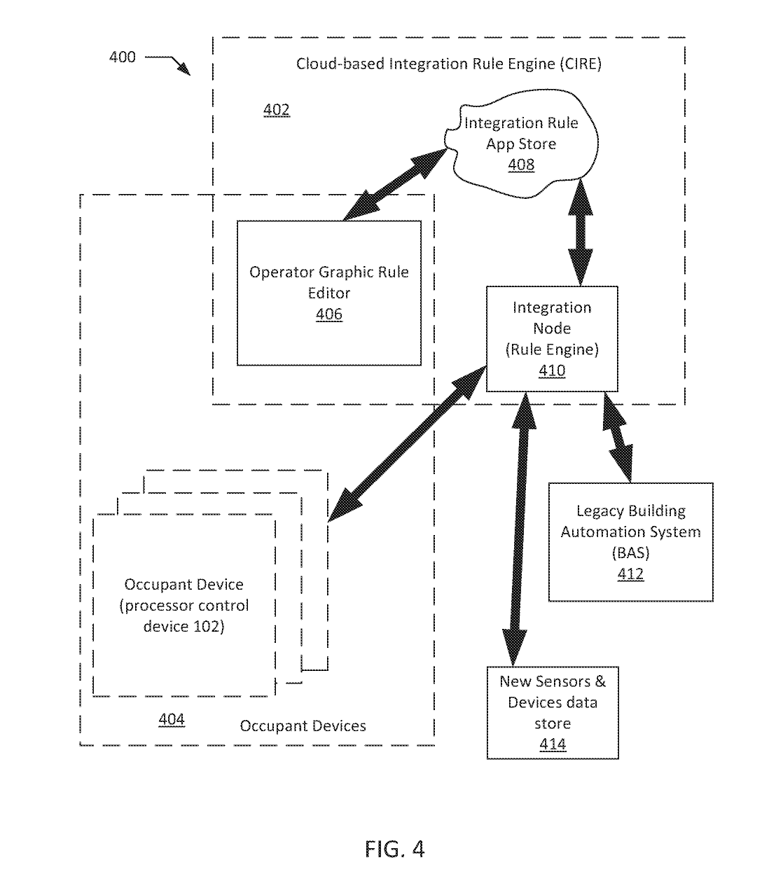

In FIG. 4, a system architecture diagram 400 of the cloud-based integration rule engine (CIRE) system 402 accessed by the processor control device 102 of FIG. 1 is depicted in accordance with an example implementation of the invention. Each of the containers depicted and control signals depicted in graphical user interface 360 of FIG. 3 depicted on an occupant device 404, such as processor control device 102. The graphical user interface 360 enables the creation and editing of containers and control signals using the operator graphic rule editor 406. The machine readable instructions for the operator graphic rule editor 406 reside on a server and/or in the cloud. In other implementations, the machine readable instructions may ride locally on the processor control device 102. In yet other implementation, the machine readable instructions may reside in both the local processor control device 102 and server in the cloud/server that is part of the CIRE 402.

The creation of containers and control signals is accomplished by an end user by accessing an integration rule application store 408 data store located in the cloud on a server. The selected container or control signal may then be placed into an already created container or linked to other containers by control signals that have been predefined using the operator graphic rule editor 406. In other implementations, more skilled user can create new containers and control signals for use by other users and stored in the integration rule app store cloud on the server.

The containers and control signals for the building automation system edited by the operator graphic rule editor 406 are integrated into the control of the building automation system by the integration node 410 that is implemented as a rule in engine in the current implementation. The integration note 410 interfaces with the legacy building automation system 412 to updated and modify the building control system. If new sensors or devices are added to the building automation system, their configuration may be defined in the new Sensor & Device definition data store 414 and added to the integration node 410. The integration node 410 may also update the integration rule application store 408 when changes occur in the legacy building automation system 412 and/or when new sensors and devices are defined in the new sensors and devices data store 414.

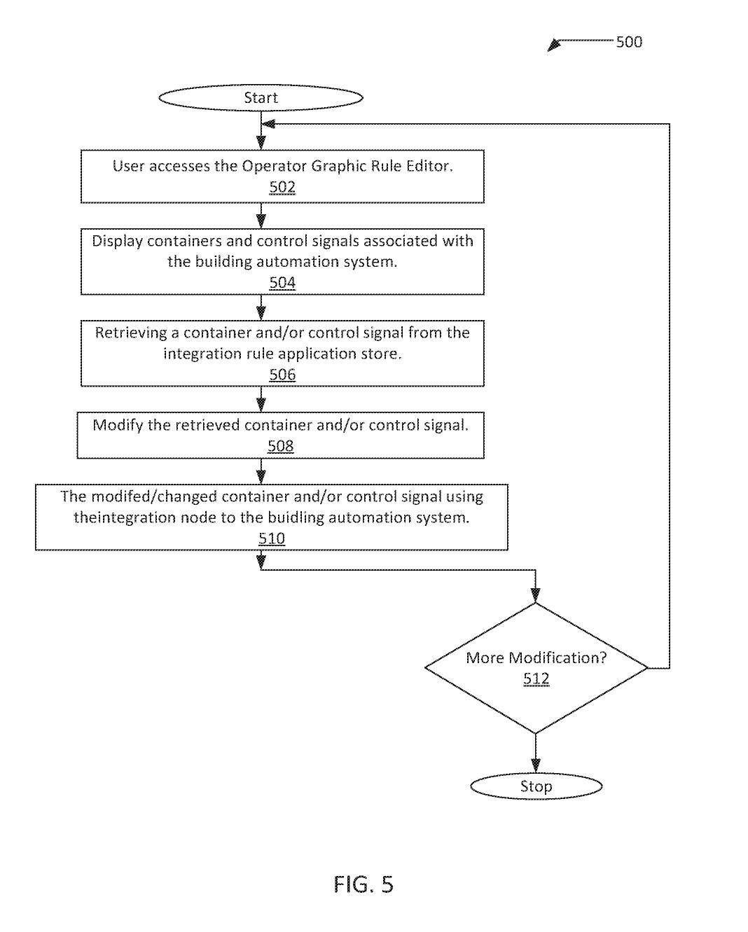

Turning to FIG. 5, a flow diagram 500 of a CI RE approach 402 to management of the BAS 200 of FIG. 2 executed on processor control device 102 of FIG. 1 is depicted in accordance with an example implementation. The user of processor control device 102 accesses the operator graphic rule editor 406 in step 502. A display of containers and control signals, such as shown in FIG. 3 associated with the building automation system 136 is depicted in the graphic rule editor 406 in step 504. Retrieving a container and/or control signal from the integration rule application store 408 and display the container and/or control signal in the operator graphic rule editor 406 in step 506. In step 508, the retrieved container and/or control signal is modified. Apply the modified container and/or control signal using the integration node 410 (orchestrator) and interact with the different components of the BAS 412 in step 510. In step 512, a check is made if more modifications are required. If so, processing continues at step 502.

The application store is a remote data store and often described as cloud based data store accessible via a predetermined application running on a computer, terminal, personal communication device, PDA, or similar device. The application store contains containers of finite state machines that in some implementations may be XML-files. A search can be accomplished in the application store for containers, such as after-hours lighting, holiday temperature, or other containers. The selected container/containers are then downloaded and the user is prompted for any additional data needed for the container (i.e. temperature, time, location, etc. . . . ). The container is then sent to the rule engine to be integrated into the BAS.

It will be understood, and is appreciated by persons skilled in the art, that one or more processes, sub-processes, or process steps described in connection with FIG. 5 may be performed by hardware and/or software (machine readable instructions). If the approach is performed by software, the software may reside in software memory in a suitable electronic processing component or system such as one or more of the functional components or modules schematically depicted in the figures.

The software in software memory may include an ordered listing of executable instructions for implementing logical functions (that is, “logic” that may be implemented either in digital form such as digital circuitry or source code or in analog form such as analog circuitry or an analog source such an analog electrical, sound or video signal), and may selectively be embodied in any computer-readable medium for use by or in connection with an instruction execution system, apparatus, or device, such as a computer-based system, processor-containing system, or other system that may selectively fetch the instructions from the instruction execution system, apparatus, or device and execute the instructions. In the context of this disclosure, a “computer-readable medium” is any tangible means that may contain or store the program for use by or in connection with the instruction execution system, apparatus, or device. The tangible computer readable medium may selectively be, for example, but is not limited to, an electronic, magnetic, optical, electromagnetic, infrared, or semiconductor system, apparatus or device. More specific examples, but nonetheless a non-exhaustive list, of tangible computer-readable media would include the following: a portable computer diskette (magnetic), a RAM (electronic), a read-only memory “ROM” (electronic), an erasable programmable read-only memory (EPROM or Flash memory) (electronic) and a portable compact disc read-only memory “CDROM” (optical). Note that the computer-readable medium may even be paper (punch cards or punch tape) or another suitable medium upon which the instructions may be electronically captured, then compiled, interpreted or otherwise processed in a suitable manner if necessary, and stored in a computer memory.

The foregoing detailed description of one or more embodiments of the approach for provisioning and modifying the control of a BAS by accessing the cloud to get containers that are modified and processed by an integration node. It will be recognized that there are advantages to certain individual features and functions described herein that may be obtained without incorporating other features and functions described herein.

Moreover, it will be recognized that various alternatives, modifications, variations, or improvements of the above-disclosed embodiments and other features and functions, or alternatives thereof, may be desirably combined into many other different embodiments, systems or applications. Presently unforeseen or unanticipated alternatives, modifications, variations, or improvements therein may be subsequently made by those skilled in the art which are also intended to be encompassed by the appended claims. Therefore, the spirit and scope of any appended claims should not be limited to the description of the embodiments contained herein.

What is claimed is:

1. A method for configuration of a building automation system (BAS), comprising:
displaying in a display of a processor control device a container representing a state machine, where the state machine is associated with instructions for controlling devices in the (BAS);
changing parameters associated with the container resulting in a changed container; and
submitting the changed container to an integration node, where an integration node is able to modify the programming of the BAS.

2. The method for configuration of the BAS of claim 1, further includes:
accessing an application store with the processor control device via a network;
selecting the container; and
downloading the container to the processor control device for displaying on the display.

3. The method for configuration of the BAS of claim 2, where the application store resides in a cloud server accessed via the network.

4. The method for configuration of the BAS of claim 1, where the container is implemented in an extended markup language (XML).

5. The method for configuration of the BAS of claim 1, further includes:
modifying the BAS in response to the integration node; and
updating the BAS in response to new devices employed in the integration node.

6. The method for configuration of the BAS of claim 1, where the integration node is implemented as a rule engine.

7. The method for configuration of the BAS of claim 1, where the displaying in the display of the container further includes:
accessing a graphical rule editor via the processor controlled device; and
displaying in the graphical rule editor the container in the display.

8. A system for configuration of a building automation system (BAS), comprising:
a display coupled to a processor in the processor controlled device that displays a container representing a state machine, where the state machine is associated with instructions for controlling devices in the (BAS);
an interface executed on the processor controlled device that enables parameters associated with the container to be changed that results in a changed container; and
a network interface that enables submission of the changed container to an integration node, where the integration node is able to modify the programming of the BAS.

9. The system for configuration of the BAS of claim 8, further includes:
an application store accessed via the network in response to the processor controlled device;
an interface associated with the application store for selection of the container; and
storing the container in memory on the processor controlled device received via the network from the application store.

10. The system for configuration of the BAS of claim 9, where the application store resides in a cloud server accessed via the network.

11. The system for configuration of the BAS of claim 8, where the container is implemented in an extended markup language (XML).

12. The system for configuration of the BAS of claim 8, further includes, a program in the BAS being modified in response to the integration node and the changed container.

13. The system for configuration of the BAS of claim 8, where the integration node is implemented as a rule engine.

14. The system for configuration of the BAS of claim 8, includes a graphical rule editor executed by the processor controlled device that displays the container in the display.

15. A non-transient machine readable instructions, that when executed implement a method for configuration of a building automation system (BAS), comprising:
displaying in a display of a processor control device a container representing a state machine, where the state machine is associated with instructions for controlling devices in the (BAS);
changing parameters associated with the container resulting in a changed container; and
submitting the changed container to an integration node, where the integration node is able to modify the programming of the BAS.

16. The non-transient machine readable instructions, that when executed implement the method for configuration of the BAS of claim 15, further includes instructions for:
accessing an application store with the processor control device via a network;
selecting the container; and
downloading the container to the processor control device for displaying on the display.

17. The non-transient machine readable instructions, that when executed implement the method for configuration of the BAS of claim 16, where the application store resides in the cloud server accessed via the network.

18. The non-transient machine readable instructions, that when executed implement the method for configuration of the BAS of claim 15, where the container is implemented in an extended markup language (XML).

19. The non-transient machine readable instructions, that when executed implement the method for configuration of the BAS of claim 15, further includes:
modifying the BAS in response to the integration node; and
updating the BAS in response to new devices employed in the integration node.

20. The non-transient machine readable instructions, that when executed implement the method for configuration of the BAS of claim 15, where the integration node is implemented as a rule engine.

21. The non-transient machine readable instructions, that when executed implement the method for configuration of the BAS of claim 15, where the instructions for displaying in the display of the container further includes:
accessing a graphical rule editor via the processor controlled device; and
displaying in the graphical rule editor the container in the display.
